(19) United States
(12) Patent Application Publication
(10) Pub. No.: US 2008/0281923 A1
(43) Pub. Date: Nov. 13, 2008

(54) Distribution List Management via SMS

(75) Inventor: Ronald S. Barchi, Maple Valley, WA (US)

Correspondence Address: WOODCOCK WASHBURN LLP, CIRA CENTRE 12th Floor, 2929 ARCH STREET, PHILADELPHIA, PA, 19104-2891, US

(73) Assignee: Cingular Wireless II, LLC, Atlanta, GA (US)

(21) Appl. No.: 11/746,827

(22) Filed: May 10, 2007

(51) Int. Cl. G06F 15/16

(52) U.S. Cl. 709/206

(57) ABSTRACT

The ability to manage and use a group distribution list by sending command codes in messages sent via a short messaging service is provided for. Management and usage may include receiving an SMS message having a command code, interpreting the message to retrieve the command code, and executing the command code. A system for managing and using a distribution list may include a short messaging service, and a group distribution list manager configured to receive a message via the short messaging service, interpret the message to retrieve a command code contained within the message, and execute the command code. A computer-readable medium comprising computer-readable instructions for managing and using group distribution lists may include instructions that interpret a short messaging service message, wherein the message contains a command code, retrieve the command code, and execute the command code.

### FIELD OF THE INVENTION

The technical field generally relates to communications systems and more specifically relates to managing and utilizing a distribution list via Short Message Service (SMS) systems.

### BACKGROUND OF THE INVENTION

E-mail programs have proliferated in recent years. To more efficiently utilize e-mail programs, the concept of broadcasting messages to one or more groups of recipients have been developed whereby a single message may be simultaneously sent to multiple recipients. Such email groups are typically created by either a user or administrator and include the email addresses of the group of recipients. Such groups are then provided a group name, or alias, by which a user would reference that group. Hence, by way of example, an email group comprising all of the attorneys in a particular branch office of a firm may be named BranchOfficeAttorneys while an email group comprising all of the attorneys in a firm regardless of location may be named AllAttorneys.

More recently, wireless email and other wireless data messaging applications have been developed which provide functionality that may be found in the land-line based email systems. The GSM specification defines one such data messaging application known as Short Messaging Service (“SMS”). SMS permits a user to send a data message to another user through the wireless data network. A user may create group distribution lists and send messages to a particular group using SMS. However, SMS is limited in that the management of the group distribution list is performed vis-à-vis a separate interface, such as a web page, than the interface used to send messages.

### SUMMARY OF THE INVENTION

Mechanisms are provided that allow for the management of group distribution lists using command codes contained in messages sent using SMS. An example embodiment may include receiving an SMS message, wherein the SMS message comprises a command code, interpreting the message to retrieve the command code, and performing the command code. Another example embodiment may include sending an SMS message, wherein the SMS message comprises a command code and content. A still further embodiment may include a system for managing and using a distribution list comprising a short messaging service, and a group distribution list manager configured to receive a message via the short messaging service, interpret the message to retrieve a command code contained within the message, and execute the command code. Another example embodiment may include a computer-readable medium comprising computer-readable instructions for managing and using group distribution lists, the computer-readable instructions comprising instructions that interpret a short messaging service message, wherein the message contains a command code, retrieve the command code, and execute the command code.

### BRIEF DESCRIPTION OF THE DRAWINGS

The foregoing summary, as well as the following detailed description, is better understood when read in conjunction with the appended drawings.

FIG. 1 illustrates an exemplary GSM/GPRS/IP multimedia network architecture;

FIG. 2 is a diagram illustrating a typical SMS system;

FIG. 3 is a flow diagram illustrating a method for managing a distribution list via SMS; and

FIG. 4 is a flow diagram illustrating the method of using distribution lists in conjunction with SMS.

### DETAILED DESCRIPTION OF ILLUSTRATIVE EMBODIMENTS

The subject matter of the described embodiments is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described. It should be understood that the explanations illustrating data or signal flows are only exemplary. The following description is illustrative and non-limiting to any one aspect.

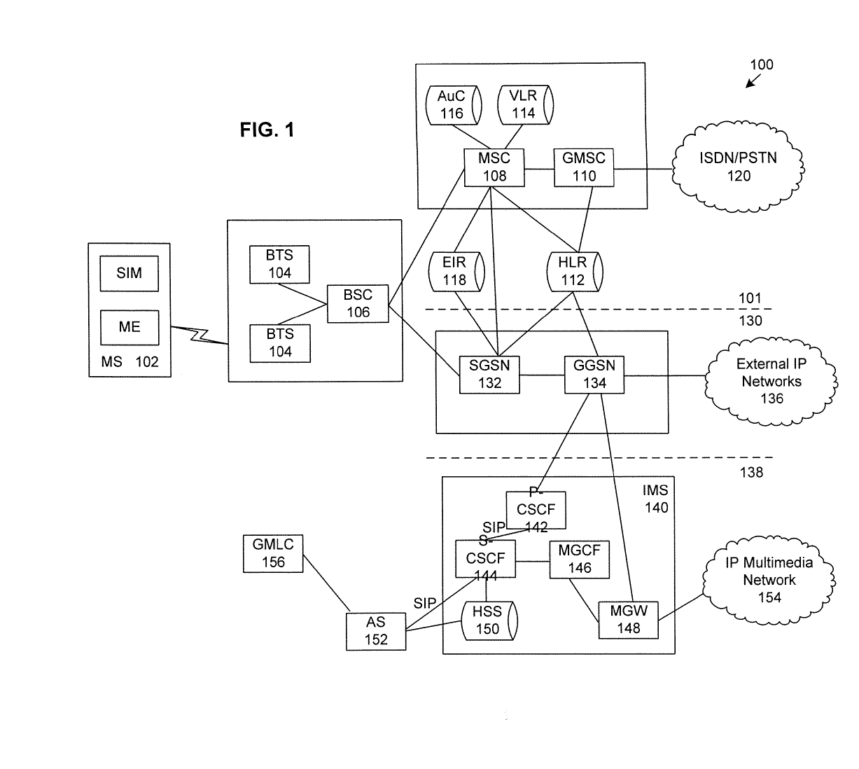

FIG. 1 shows a GSM/GPRS/IP multimedia network architecture 100 that includes a GSM core network 101, a GPRS network 130 and an IP multimedia network 138. The GSM core network 101 includes a Mobile Station (MS) 102, at least one Base Transceiver Station (BTS) 104 and a Base Station Controller (BSC) 106. The MS 102 is physical equipment or Mobile Equipment (ME), such as a mobile phone or a laptop computer that is used by mobile subscribers, with a Subscriber identity Module (SIM). The SIM includes an International Mobile Subscriber Identity (IMSI), which is a unique identifier of a subscriber. The BTS 104 is physical equipment, such as a radio tower, that enables a radio interface to communicate with the MS. Each BTS may serve more than one MS. The BSC 106 manages radio resources, including the BTS. The BSC may be connected to several BTSs. The BSC and BTS components, in combination, are generally referred to as a base station (BSS) or radio access network (RAN) 103.

The GSM core network 101 also includes a Mobile Switching Center (MSC) 108, a Gateway Mobile Switching Center (GMSC) 110, a Home Location Register (HLR) 112, Visitor Location Register (VLR) 114, an Authentication Center (AuC) 118, and an Equipment Identity Register (EIR) 116. The MSC 108 performs a switching function for the network. The MSC also performs other functions, such as registration, authentication, location updating, handovers, and call routing. The GMSC 110 provides a gateway between the GSM network and other networks, such as an Integrated Services Digital Network (ISDN) or Public Switched Telephone Networks (PSTNs) 120. In other words, the GMSC 110 provides interworking functionality with external networks.

The HLR 112 is a database that contains administrative information regarding each subscriber registered in a corresponding GSM network. The HLR 112 also contains the current location of each MS. The VLR 114 is a database that contains selected administrative information from the HLR 112. The VLR contains information necessary for call control and provision of subscribed services for each MS currently located in a geographical area controlled by the VLR. The HLR 112 and the VLR 114, together with the MSC 108, provide the call routing and roaming capabilities of GSM. The AuC 116 provides the parameters needed for authentication and encryption functions. Such parameters allow verification of a subscriber's identity. The EIR 118 stores security-sensitive information about the mobile equipment.

To gain access to GSM services, such as speech, data, and short message service (SMS), the MS first registers with the network to indicate its current location by performing a location update and IMSI attach procedure. The MS 102 sends a location update including its current location information to the MSC/VLR, via the BTS 104 and the BSC 106. The location information is then sent to the MS's HLR. The HLR is updated with the location information received from the MSC/VLR. The location update also is performed when the MS moves to a new location area. Typically, the location update is periodically performed to update the database as location updating events occur.

The GPRS network 130 is logically implemented on the GSM core network architecture by introducing two packet-switching network nodes, a serving GPRS support node (SGSN) 132 and a Gateway GPRS support node (GGSN) 134. The SGSN 132 is at the same hierarchical level as the MSC 108 in the GSM network. The SGSN controls the connection between the GPRS network and the MS 102. The SGSN also keeps track of individual MS's locations and security functions and access controls. The GGSN 134 provides a gateway between the GPRS network and a public packet network (PDN) or other IP networks 136. That is, the GGSN provides interworking functionality with external networks, and sets up a logical link to the MS through the SGSN. When packet-switched data leaves the GPRS network, it is transferred to an external TCP-IP network 136, such as an X.25 network or the Internet. In order to access GPRS services, the MS first attaches itself to the GPRS network by performing an attach procedure. The MS then activates a packet data protocol (PDP) context, thus activating a packet communication session between the MS, the SGSN, arc the GGSN.

In a GSM/GPRS network, GPRS services and GSM services can be used in parallel. The MS can operate in one three classes: class A, class B, and class C. A class A MS can attach to the network for both GPRS services and GSM services simultaneously. A class A MS also supports simultaneous operation of GPRS services and GSM services. For example, class A mobiles can receive GSM voice/data/SMS calls and GPRS data calls at the same time.

A class B MS can attach to the network for both GPRS services and GSM services simultaneously. However, a class B MS does not support simultaneous operation of the GPRS services and GSM services. That is, a class B MS can only use one of the two services at a given time.

A class C MS can attach for only one of the GPRS services and GSM services at a time. Simultaneous attachment and operation of GPRS services and GSM services is not possible with a class C MS.

A GPRS network 130 can be designed to operate in three network operation modes (NOM1, NOM2 and NOM3). Network operation modes of a GPRS network is indicated by a parameter in system information messages transmitted within a cell. The system information messages dictates a MS where to listen for paging messages and how signal towards the network. The network operation mode represents the capabilities of the GPRS network. In a NOM1 network, a MS can receive pages from a circuit switched domain (voice call) when engaged in a data call. The MS can suspend the data call or take both simultaneously, depending on the ability of the MS. In a NOM2 network, a MS may not received pages from a circuit switched domain when engaged in a data call, since the MS is receiving data and is not listening to a paging channel. In a NOM3 network, a MS can monitor pages for a circuit switched network while received data and vise versa.

The IP multimedia network 138 was introduced with 3GPP Release 5, and includes an IP multimedia subsystem (IMS) 140 to provide rich multimedia services to end users. A representative set of the network entities within the IMS 140 are a call/session control function (CSCF), a media gateway control function (MGCF) 146, a media gateway (MGW) 148, and a master subscriber database, called a home subscriber server (HSS) 150. The HSS 150 may be common to the GSM network 101, the GPRS network 130 as well as the IP multimedia network 138.

The IP multimedia system 140 is built around the call/session control function, of which there are three types: an interrogating CSCF (I-CSCF) 143, a proxy CSCF (P-CSCF) 142, and a serving CSCF (S-CSCF) 144. The P-CSCF 142 is the MS's first point of contact with the IMS 140. The P-CSCF 142 forwards session initiation protocol (SIP) messages received from the MS to an SIP server in a home network (and vice versa) of the MS. The P-CSCF 142 may also modify an outgoing request according to a set of rules defined by the network operator (for example, address analysis and potential modification).

The I-CSCF 143, forms an entrance to a home network and hides the inner topology of the home network from other networks and provides flexibility for selecting an S-CSCF. The I-CSCF 143 may contact a subscriber location function (SLF) 145 to determine which HSS 150 to use for the particular subscriber, if multiple HSS's 150 are present. The S-CSCF 144 performs the session control services for the MS 102. This includes routing originating sessions to external networks and routing terminating sessions to visited networks. The S-CSCF 144 also decides whether an application server (AS) 152 is required to receive information on an incoming SIP session request to ensure appropriate service handling. This decision is based on information received from the HSS 150 (or other sources, such as an application server 152). The AS 152 also communicates to a location server 156 (e.g., a Gateway Mobile Location Center (GMLC)) that provides a position (e.g., latitude/longitude coordinates) of the MS 102.

The HSS 150 contains a subscriber profile and keeps track of which core network node is currently handling the subscriber. It also supports subscriber authentication and authorization functions (AAA). In networks with more than one HSS 150, a subscriber location function provides information on the HSS 150 that contains the profile of a given subscriber.

The MGCF 146 provides interworking functionality between SIP session control signaling from the IMS 140 and ISUP/BICC call control signaling from the external GSTN networks (not shown). It also controls the media gateway (MGW) 148 that provides user-plane interworking functionality (e.g., converting between AMR- and PCM-coded voice). The MGW 148 also communicates with other IP multimedia networks 154.

In many mobile devices and systems, text messaging is implemented utilizing the Short Message Service (SMS). SMS supports transmission of alphanumeric messages between mobile devices or entities, such as mobile telephones, for example. SMS may also be used in communication between a mobile device and a personal computer. The present invention is applicable to both types of communications.

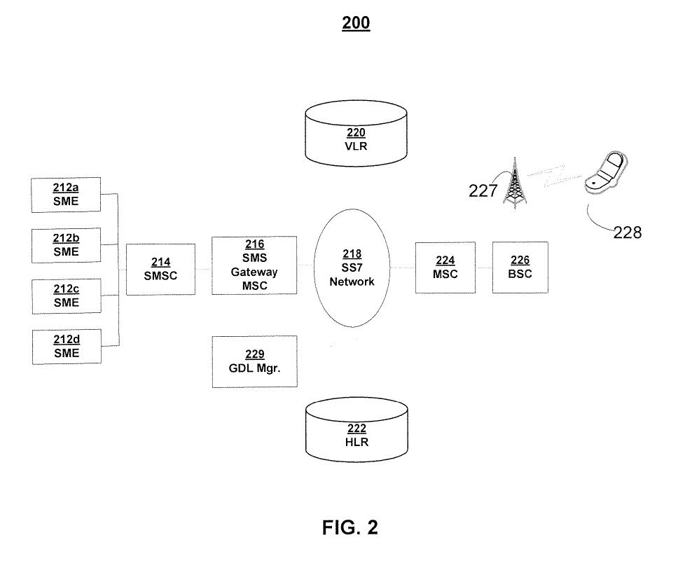

FIG. 2 is illustrative of an exemplary SMS system. Shown is system architecture 200 having multiple short messaging entities (SME) 212a-d. SME 212a-d are devices which may receive or send short messages. SME 212a-d may be located in the fixed network or a service center. SME 212a-d may also be a mobile station, such as mobile station 228. Mobile station 228 may be, for example, a mobile cellular telephone, PDA, mobile computer, portable computer with a wireless cellular card, or any other type of mobile communication station. SME 212a-d communicates with short message service center (“SMSC”) 214. SMSC 214 is a server which is typically responsible for the relaying, store and forwarding of short messages between an SME and mobile station.

SMSC 214 communicates with SMS Gateway Mobile Switching Center (“SMS Gateway MSC”) 216. SMS Gateway MSC 216 is a MSC capable of receiving a short message from an SMSC, interrogating a home location register (“HLR”) 222 and/or visitor location register (“VLR”) 220 for routing information and delivering the short message to the serving or visited MSC 224 of the recipient mobile station 228. HLR 222 is a database used for permanent storage and management of subscriptions and service profiles for various users, while VLR 220 is a database that contains temporary information about subscribers. For example, HLR 222 may store static information about the subscribers such as the International Mobile Subscriber Identity (“IMSI”), subscribed services, and a key for authenticating the subscriber. HLR 222 may also store dynamic subscriber information such as the current location of the mobile subscriber.

The interrogation and other control communications between the SMS Gateway MSC 16, MSC 224, HLR 222 and VLR 220 are performed across SS7 network 218. Protocols other than SS7 network 218 may be used, such as, but not limited to, TCP/IP. HLR 222 provides the routing information for mobile station 228 associated with the indicated subscriber, tapping into VLR 220 database for those of its subscribers that may be roaming. Serving or visited MSC 224 for mobile station 228 communicates with mobile station 228 through base station controller (“BSC”) 226 and base station tower 227.

The functionality of the present invention may be implemented by software commands or hardware or a combination thereof. It is preferable that the intelligence required to implement the present invention be included in SMS Gateway MSC 216.

By way of example only, the various commands as may be implemented by software are set forth herein, not to limit the invention but rather to serve as examples thereof. Because SMS is a two-way communication protocol, the source of the messages used to manage a group distribution list (“GDL”) will be identified by the source address in the SMS header which is typically the MSISDN. The destination will be the destination address in the SMS header, which may, for example, be a short code or long code associated with GDL manager 229. GDL manager 229 provides for the GDL management functions described hereinafter. When a user wishes to perform a management function on the group distribution list, the user will send a message using SMS, whereby the message contains the management command. The command may be received at GDL manager 229, whereupon the command is executed.

With respect to exemplary and non-limiting examples of group distribution list (“GDL”) management functions may include the modification of group distribution lists. There may be the following representative group distribution lists commands, as shown in the table below:

| FUNCTION | COMMAND | ACTION |
|---|---|---|
| Create a New | a GROUPNAME (or add, new, | Where a, add, new, or group |
| Group | group) | is the command and |
| | | GROUPNAME is the name |
| | | of the group to be added |
| Modify a Group | m OLDGROUPNAME, NEW | where m, mod, or modify is |
| Name | GROUPNAME (or mod, modify) | the command and |
| | | OLDGROUPNAME is the |
| | | name of the group to be |
| | | changed and |
| | | NEWGROUPNAME is the |
| | | new name of that group |
| Delete a Group | d GROUPNAME (or del, delete) | where d, del or delete is the |
| Name | | command and |
| | | GROUPNAME is the name |
| | | of the group to be deleted |
| Forward a Group | F GROUPNAME destination | where f, for, forward is the |
| | MSISDN (or for, forward) | command and |
| | | GROUPNAME is the name |
| | | of the group to be forwarded |
| | | to the destination identified |
| | | by the MSISDN, the address |
| | | of the subscriber that will |
| | | receive the group distribution |
| | | list into the address book |
| Merge Multiple | merge NEWGROUPNAME | where merge is the command, |
| Groups | GROUPNAME1, | NEWGROUPNAME is the |
| | GROUPNAME2, . . . GROUPNAMEn | name of the merged groups |
| | | comprising GROUPNAME1 |
| | | through GROUPNAMEn |
| Add a member to | a GROUPNAME, MEMBER1, | where a, add, or group is the |
| the Group (Invite) | MEMBER2, . . . MEMBERn (or add, | command, GROUPNAME is |
| | group) | the name of the group to be |
| | | added to, and MEMBER1 |
| | | through MEMBERn are the |
| | | MSISDN's of the subscribers |
| | | to be added to the group |
| Delete a Member | d GROUPNAME, MEMBER1, | where d, del, or delete is the |
| from the group | MEMBER2, . . . MEMBERn (or del, | command, GROUPNAME is |
| | delete) | the name of the group to be |
| | | added to, and MEMBER1 |
| | | through MEMBERn are the |
| | | MSISDN's of the subscribers |
| | | to be deleted from the group |
| Request being | addme GROUPNAME | where addme is the command |
| added to a Group | | and GROUPNAME the |
| | | sender wishes to be added to. |
| | | Rather than permit anyone to |
| | | alter a GDL by this |
| | | command, the addme |
| | | command is merely a request |
| | | to the administrator of the |
| | | GDL to add the requestor |
| Opt-in to a Group | GROUPNAME | where GROUPNAME is the |
| (accept invite) | | name of the group to be |
| | | added |
| Opt-out of a | GROUPNAME stop (out, optout, | where GROUPNAME is the |
| Group | uninvited, unlist, or remove) | name of the group that a user |
| | | would like to opt-out of and |
| | | stop, out, optout, uninvited, |
| | | unlist, or remove would be |
| | | the command to trigger the |
| | | opt-out action. |

With respect to exemplary and non-limiting examples of group distribution list (“GDL”) management functions may include group distribution list usage or message handling. There may be the following representative usage or message handling commands, as shown in the table below:

| FUNCTION | COMMAND | ACTION |
|---|---|---|
| Compose a | GROUPNAME message | where GROUPNAME is the name of the |
| Message to a | | group to receive the message and |
| Group | | message is the content of the message to |
| | | be sent |
| Reply to a | GROUPNAME message | where GROUPNAME is the name of the |
| Message Sent to | | group to receive the message and |
| a Group | | message is the content of the message to |
| | | be sent |
| Retrieve the | GROUPNAME list | where GROUPNAME is the name of the |
| Group List | | group one would like to send a message |
| Members | | and list is the command to request the list |
| | | of source addresses in the group. This |
| | | may, for example, would in conjunction |
| | | with the Opt-out or Opt-in commands |
| | | where the list would include those in the |
| | | list that select Opt-in and/or exclude |
| | | those in the list that selected Opt-out |
| Request Filter of | GROUPNAME ex | where GROUPNAME is the group to |
| Messages Sent to | FILTER (or exclude) | which you want to apply the filter; ex, |
| a Group | GROUPNAME in | exclude, in, or include is the command |
| | FILTER (or include) | and FILTER is the content to which you |
| | | want to trigger the inclusion or exclusion |

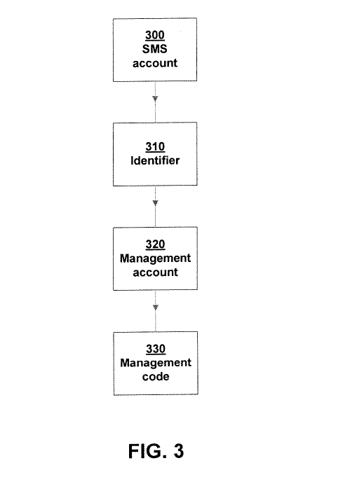

FIG. 3 illustrates an exemplary and non-limiting way of using the present disclosure. First, at step 300, the user will establish an SMS account with a service provider and at step 310, an identifier to be used in association with the account will be established. An identifier is used to determine the identification of the transmitting device. For example, the MSISDN for a cell phone may be the identifier associated with the SMS account. Once the SMS account has been established, at step 320 a global distribution list management account is established. The management account may be established upon initialization of the SMS account or when the user, through some input, indicates that group distribution list management capabilities are desired.

In conjunction with the establishment of the management account at step 320, a management account code is established at step 330. When the user desires to perform management or usage functions on a group distribution list, the user sends the management or usage message to the code rather than the number or identification of a destination device, such as another cell phone.

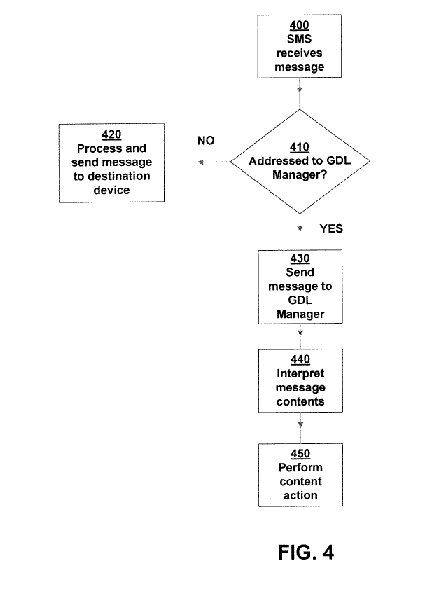

FIG. 4 illustrates an exemplary and non-limiting method of handling SMS messages. At step 400, the SMS receives a message sent by a user. At step 410, the addressee is determined. If it is determined to be a message addressed to another user or system, at step 420 the message is processed normally through SMS. If it is determined that the message is addressed to the GDL manager, e.g. the address is to the management account code as the addressee rather than a phone number, for example, at step 430 the message is sent to the GDL manager for processing. At step 440, the message contents are interpreted to determine the action the user wishes to take. For example, the management account code may be “1212”. The user may wish to create a group. The user will send the message, “add groupname” to “1212”. The present disclosure is not limited to any particular text of command, as other commands may be used for the same or different commands. Additionally, the management account code is not limited to numerical code, but may also be alphanumeric, and any combination thereof.

Once the message is sent to the GDL manager at step 440, the message contents are interpreted to determine the requested action. The interpretation of the message may be done in various ways or by using various systems. In this example, the GDL manager is configured to interpret the message contents. Once the message contents and the command are determined, the command is executed upon at step 450. The execution of the command may be performed using various systems. In this example, the GDL manager is configured to execute the command.

The various techniques described herein may be implemented with hardware or software or, where appropriate, with a combination of both. Thus, the methods and apparatus of the disclosed embodiments, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the disclosed embodiments

In the case of program code execution on programmable computers, the computer will generally include a processor, a storage medium readable by the processor (including volatile and non-volatile memory and/or storage elements), at least one input device and at least one output device. One or more programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

The described methods and apparatus may also be embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, the machine becomes an apparatus for practicing the invention. When implemented on a general-purpose processor, the program code combines with the processor to provide a unique apparatus that operates to perform the processing of the disclosed embodiments.

While the embodiments have been described in connection with the preferred embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

What is claimed:

1. A method of managing a group distribution list, comprising:
receiving a short messaging service (SMS) message, wherein the SMS message comprises a command code;
interpreting the message to retrieve the command code; and
executing the command code.

2. The method of claim 1, wherein the command code comprises a command to modify the group distribution list.

3. The method of claim 2, wherein the command to modify the group distribution list comprises a command to add a member to the group distribution list or a command to remove a member from the group distribution list.

4. The method of claim 1, wherein the command code comprises a command to establish a new group distribution list.

5. The method of claim 1, wherein the command code comprises a request from a new user that the new user be added to or deleted from the group distribution list.

6. The method of claim 1, wherein the command code comprises a command to merge at least a part of the group distribution list with at least a part of a second group distribution list.

7. The method of claim 1, wherein the command code comprises a command to opt-in or opt-out of the group distribution list.

8. A method of managing and using a group distribution list, comprising:
generating an SMS message, wherein the SMS message comprises a command code and content; and
sending the SMS message to a group distribution list manager.

9. The method of claim 8, wherein sending the SMS message comprises:
sending the SMS message to the management account code assigned to the group distribution list manager.

10. The method of claim 8, wherein the command code comprises a command to compose a message to a group in the group distribution list, wherein the content comprises the message to send to the group.

11. The method of claim 8, wherein the command code comprises a command to reply to a prior message sent to a group in the group distribution list, wherein the content comprises the reply message to send to the group.

12. The method of claim 8, wherein the command code comprises a command to retrieve a list of members associated with a group in the group distribution list, wherein the content comprises a name of the group.

13. The method of claim 8, wherein the command code comprises a command to request a filter of message sent to a group in the group distribution list, wherein the content comprises the message filter.

14. A system for managing and using a distribution list, comprising:
a short messaging service; and
a group distribution list manager configured to:
receive a message via the short messaging service;
interpret the message to retrieve a command code contained within the message; and
execute the command code.

15. The system of claim 14, wherein the short messaging service is in communication with a global system for mobile communications (GSM) network.

16. The system of claim 14, wherein the short messaging service is in communication with a general packet radio service (GPRS) multimedia network.

17. The system of claim 14, wherein the short messaging service is in communication with an internet protocol (IP) network.

18. The system of claim 14, wherein the message is sent via a cellular telephone.

19. A computer-readable medium comprising computer-readable instructions for managing and using group distribution lists, the computer-readable instructions comprising instructions that:
interpret a short messaging service message, wherein the message contains a command code;
retrieve the command code; and
execute the command code.

20. The computer-readable instructions of claim 19, wherein the command code is a management command or a usage command.
